(19) United States
(12) Patent Application Publication
(10) Pub. No.: US 2010/0328496 A1
(43) Pub. Date: Dec. 30, 2010

(54) ADVERTISING THROUGH RECYCLABLE DIGITAL CAMERAS

(75) Inventors: Eli Pozniansky, Santa Clara, CA (US); Shimon Pertsel, Sunnyvale, CA (US); Ohad Meitav, Cupertino, CA (US)

Correspondence Address: DICKSTEIN SHAPIRO LLP, 2049 CENTURY PARK EAST, SUITE 700, LOS ANGELES, CA, 90067, US

(73) Assignee: ZORAN CORPORATION, Sunnyvale, CA (US)

(21) Appl. No.: 12/879,389

(22) Filed: Sep. 10, 2010

Related U.S. Application Data
(63) Continuation of application No. 11/024,045, filed on Dec. 27, 2004.

(51) Int. Cl. H04N 5/76; G06Q 30/00; H04N 5/225

(52) U.S. Cl. 348/231.99; 705/14.4; 348/333.02; 348/E05.024

(57) ABSTRACT

Data of updated or new advertising messages are loaded into a non-volatile memory of a digital camera in the course of it being recycled. The user of the camera therefore receives the updated or new advertising messages as a part of recycling the camera. There are a number of ways the advertising message can be displayed on a picture preview screen of the camera and/or reproduced by a loudspeaker on the camera. The advertising message can either be displayed along with a picture acquired by the camera or at separate times.

### CROSS-REFERENCE TO RELATED APPLICATION(S)

This patent application is a continuation of U.S. application Ser. No. 11/024,045, filed on Dec. 27, 2004, the entire contents of which is expressly incorporated herein by reference.

### FIELD OF THE INVENTION

This invention relates generally to single use hand-held digital cameras and to methods of using and recycling them, and, more specifically, to such cameras having the ability to deliver advertising and other messages to their users and to methods of supplying such messages.

### BACKGROUND

The popularity of recyclable, single-use hand-held digital cameras among consumers is increasing for taking still photographs and/or short video clips. Recyclable video camcorders and other digital video cameras are also available. Such a camera is purchased by an end-user for a price that is much lower than if the camera is to be permanently owned. A recyclable digital camera is used by the end-user in a manner similar to a conventional digital camera, until a permitted number of pictures have been taken. At this point, the end-user returns the recyclable camera to a service center, either directly or through a retail store, for processing of the stored pictures. Subsequently, the pictures are returned to the end-user as hardcopy prints or on a standard storage medium such as a compact disk recordable (CD-R) or DVD disc recordable (DVD-R). The camera is then refurbished by the service center, or the camera's manufacturer, including erasure of its internal memory, and then returned to a retail point-of-sale such as a camera store, drug store and the like to be resold; hence the term “recyclable”.

A recyclable camera typically has only internal electronic memory for storage of picture data. No mechanism is usually provided for the end-user to retrieve the stored pictures by transferring them to a personal computer or the like, contrary to purchased cameras that are not recyclable. The stored pictures can be retrieved by the service center by means uniquely available to the service center. The recyclable digital camera is analogous to a single-use photographic film camera in its model of manufacture, usage, processing and recycling through retail points-of-sale. For this business model to be viable, the recyclable digital camera is designed to be inexpensive to manufacture.

One such camera is made by Pure Digital Technologies, Inc. and is being distributed through retail outlets. One such outlet is a national chain of retail drug stores that sells the cameras to end user customers and serves as a point of return for the cameras after their capacity to take and store pictures has been reached. One version of this camera has a preview screen that shows only the last photograph stored in its memory and allows the user to delete data of this last photograph from the memory. The user may not review and/or delete any earlier recorded photographs. Each time the camera is turned on, a display appears on the preview screen for a few seconds that identifies the retail outlet from which the camera was purchased. A recyclable digital camera is described in International Publication No. WO 03/024083 A2 of a patent application by Pure Digital Technologies, Inc.

The retail store typically sends the returned cameras to a processing center that handles such returns from a large number of retail stores. The processing center makes prints and/or an optional CD-R from the still and/or motion image data in the camera, and then sends them to the camera customer, typically through the retail store with which the end user customer is dealing.

### SUMMARY OF THE INVENTION

Generally, recyclable digital cameras are resold to camera users with advertising messages that are reproduced during normal use of the cameras to capture or review still or motion image data. Specifically, data of new or updated advertising messages are loaded into the non-volatile memory of recyclable digital cameras that have been returned for the processing of their image data and before they are resold to a customer.

The new or updated message data may be loaded by the same business entity that removes and processes the image data, such as a processing center or a retail establishment, or, alternatively, different ones of these or other business entities can perform these two functions. The new or updated advertising messages most commonly promote products or the business of entities other than the retail establishment, processing center, camera manufacturer and any other business involved directly in the camera cycle. The camera therefore becomes a general advertising medium for which advertisers pay an appropriate one or more of the business entities that are involved in manufacturing the cameras, uploading the advertising message data into the cameras, processing images from the cameras and distributing the refurbished cameras to end users.

The messages may be reproduced as images, audio, or a combination of the two. When images, the messages may be a single or multiple succession of static frames, or a motion picture. The reproduced messages may be in a variety of forms, such as traditional advertising of goods or services, or can also serve as a coupon for the camera user to obtain a discount, free sample, or the like, by showing the display to a merchant participant. Directories of restaurants, movie theaters, and other messages local to where the recyclable camera is sold, may also be included for access by the camera user. For this type of message, where the camera users may want to access and reproduce it independently of capturing their own image data, the camera preferably includes an external control actuatable by the user for this purpose. A short version of a message may be involuntarily reproduced with the user then having an option to view or listen to an expanded form of the message, an example being an advertisement for a movie with the option provided for the user to look at the full trailer for the movie.

Advertising messages can be played on the recyclable camera each time its power switch has been actuated and while it is initializing, after the taking of a picture but before it can be viewed on the camera display screen, during the taking of a picture, or other times that the ‘user is likely to be viewing the camera display screen and/or listening to the audio. A displayed message may be the only image visible on the camera screen or may overlay a picture previously taken or one being taken. It may be positioned in the corner or along an edge of the display or overlay a small portion of a displayed picture where it does not interfere with viewing that picture. The advertising message may be static or it may be moving across the display screen. Data of multiple messages may be stored in the camera and reproduced in some predefined or random order, or in response to specified conditions. Since the alternatives for reproducing the advertising message are numerous and varied, they can be reproduced by the camera in a manner that best fits the circumstances. An advertising symbol or other message can even be added to the captured image data so that the symbol becomes part of the stored image data and appears each time the pictures are viewed and on processed prints of the picture.

Rather than restricting the user from deleting captured pictures from the recycled camera, as is currently done, such deletion may be conditioned upon an advertising message first being displayed prior to the deletion being allowed. The user is then likely to be exposed to more advertising messages during each cycle of the camera's use. The camera may also keep data of the number of times various stored advertising messages are reproduced, particularly those requested by the user, as a basis for setting charges to the advertisers.

The foregoing techniques are also equally applicable to a modified business model where the end user keeps the same camera rather than getting a new one each time the allowed number of pictures are taken. In such a case, the camera owner still returns the camera to have its video data processed after the number of allowed pictures has been stored within its memory. But instead of having to purchase another camera, the user gets back the same camera for reuse.

A primary advantage to the camera user of including advertising messages is that the revenue obtained from advertisers can allow the cost of the cameras and/or video data processing to be reduced. The advertising revenue can alternatively allow more expensive cameras having increased quality, ease of use and other desirable features, to be sold for the same or little more than lesser cameras.

For manufacturers of recyclable cameras and suppliers of components for them, the lower prices will increase the number of recyclable cameras sold. The ability to improve the quality of the video captured and increase the number of features makes recyclable cameras more competitive with non-recyclable digital cameras.

To the retailer and video processor, advertising revenue can provide one or both of them with an independent source of income. This income is independent of the cost of the camera or processing. This particularly increases the interest of retail establishments to handle recyclable cameras in larger volumes.

For advertisers, the addition of changing the messages in the cameras provides another effective outlet for their advertising that continues for the lives of the cameras. Particularly when the retail establishment or a local camera distributor is responsible for the advertising content, the advertiser can target its advertisement to local audiences and therefore be more effective. The camera provides another medium for delivering complicated visual and audio advertisements, such as short video clips and even movie trailers, to an audience. These cannot now be shown to audiences except through television cable or satellite distribution, on a video/audio disc, through access to Internet sites or in movie theaters.

Additional aspects, advantages and features of the present invention are included in the following description of exemplary examples thereof, which description should be taken in conjunction with the accompanying drawings.

### BRIEF DESCRIPTION OF THE DRAWINGS

FIG. 1 is a schematic diagram of an example optical and electronic system within a hand-held digital camera;

FIG. 2 shows an outside of a camera incorporating the system of FIG. 1;

FIG. 3 is a block diagram of a workstation that processes image data acquired by the digital camera of FIGS. 1 and 2;

FIG. 4 illustrates a business method of a recyclable digital camera containing advertising;

FIG. 5 shows a modification of the schematic camera diagram of FIG. 1 wherein two non-volatile memories are used;

FIG. 6 is a flow-chart that illustrates many aspects of the operation of the digital camera of FIGS. 1 and 2;

FIG. 7 illustrates some processing steps that may optionally be included in the flow-chart of FIG. 6; and

FIGS. 8A-8H show different example displays of both a picture previously taken or currently being taken and an advertising message.

### DESCRIPTION OF EXEMPLARY EMBODIMENTS

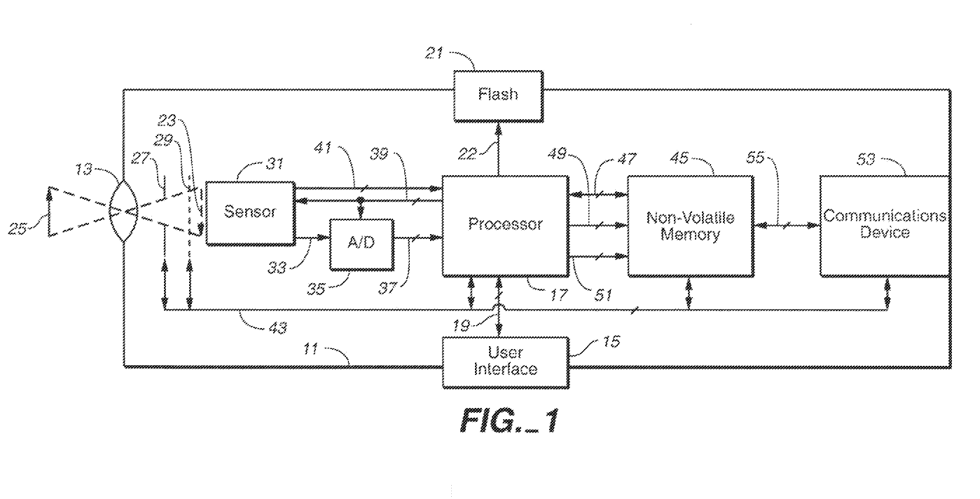

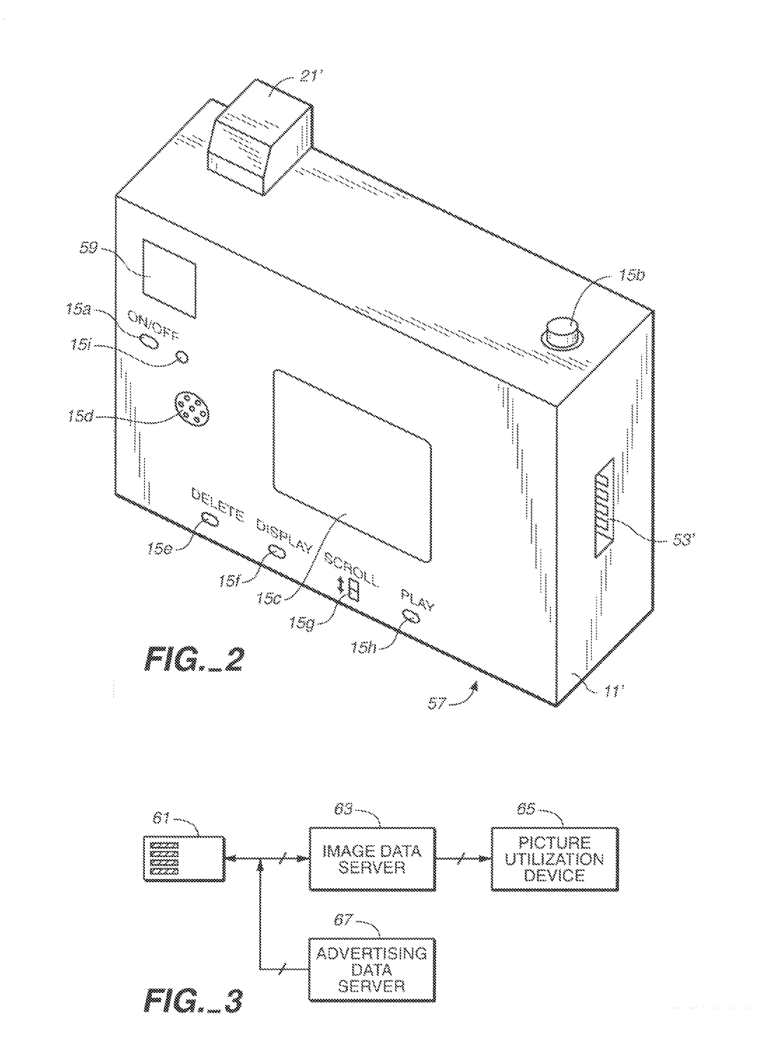

An example video data acquisition device in the form of a hand-held digital camera through which advertising messages may be delivered is shown in the schematic diagram of FIG. 1. This camera includes a case 11, an imaging optical system 13 and a user interface 15 that communicates with a processor 17 over lines 19. The interface 15 includes user operated switches and controls, as well as indicators of the operation and status of the camera, examples of which are described below with respect to FIG. 2. An optional light flash unit 21, controlled by the processor 17 through lines 22, may also be included. A battery (not shown) is also included within the case 11. The battery may be a reusable rechargeable type, either permanently installed with in the camera or removable, or may alternatively be one or more removable disposable batteries. Such a hand-held digital camera can be small, a camera body having dimensions less than 14 cm. long by 8 cm. high by 5 cm. thick, and even smaller at less than 8×4×2 centimeters, with the lens normally but not necessarily protruding a short distance from the body.

The optical system 13 can be a single lens, as shown, but will normally be a set of lenses. An image 23 of a scene 25 is formed in visible optical radiation through an adjustable aperture 27 and a shutter 29 onto a two-dimensional surface of an image sensor 31. An electrical output 33 of the sensor 31 carries an analog signal resulting from scanning individual photo-detectors of the surface of the sensor 31 onto which the image 23 is projected. The sensor 31 typically contains a large number of individual photo-detectors arranged in a two-dimensional array of rows and columns to detect individual pixels of the image 23. Signals proportional to the intensity of light striking the individual photo-detectors are obtained in the output 33 in time sequence, typically by scanning them in a raster pattern, where the rows of photo-detectors are scanned one at a time from left to right, beginning at the top row, to generate a frame of data of a scene from which the image 23 may be reconstructed. The photo-detectors are typically sensitive to light one of the primary colors such as red, green and blue (RGB). The analog signal 33 is applied to an analog-to-digital converter circuit chip 35 that generates digital data of the image 23 in circuits 37. Typically, the signal in circuits 37 is a sequence of individual blocks of digital data representing the intensity of light striking the individual photo-detectors of the sensor 31.

In the example camera of FIG. 1, the processor 17 includes a system clock, and a clock signal is supplied by the processor to the sensor 31 and analog-to-digital converter 35 over lines 39. Additional timing signals for synchronizing operation of the sensor 31 and the processor 17 are also generated within the processor 17 and supplied over lines 41 to the sensor 31. Alternatively, a separate system clock may be utilized and/or the synchronizing timing signals may be generated in the sensor 31 and supplied to the processor 17 instead. The processor chip 17 is connected through control and status lines 43 to the variable aperture 27, the shutter 29 and other components of the camera in order to control them. Instead of a mechanical shutter 29, electronic signal gating circuitry can be utilized.

A non-volatile memory 45 installed within the camera stores data of images captured by the camera sensor 31 and data of advertising messages delivered through the camera. The memory 45 can be a commercially available semiconductor flash electrically erasable and programmable read-only-memory (EEPROM), small removable rotating magnetic or optical disk, magnetic tape, volatile semiconductor memory with a battery back-up or other type of re-programmable non-volatile memory. Data of a large number of individual frames of data are written into the memory 45 over lines 47 from the processor 17 as the sensor 31 acquires these data. Control lines 49 allow the processor 17 to control operation of the memory 45. Additional image support data useful or necessary for subsequent processing of the image data are also programmed in the memory 45 over lines 51 along with the image frame data that they support. Data of images to be displayed are read from the memory 45 by the processor 17 over the lines 47, as are data of advertising messages. Audio data may also be stored in the memory 45 in conjunction with the still, motion and/or commercial message data.

Although the memory 45 can be made to be physically removable from the camera by use of a flash memory card or removable small hard disk system, the memory 45 is typically permanently installed within the camera case 11. Image data are transferred out of the camera, and advertising message data into the camera, through a communications device 53 operably connected with the memory 45 over lines 55. The communications device 53 can take a number of different forms, such as a socket into which a cable is connectable, an infrared (IR) digital data transmission device, a radio-frequency (RF) signal transmitter, or other type of wireless data communications link.

Alternatively, if the non-volatile memory 45 is in a form that is removable from the camera, it is configured to be removable by technicians at the processing service center after opening the case 11. The camera user can be effectively prevented from removing the memory card from inside the camera by use of a unique locking device on its case that only a technician with a special tool can open. Alternatively, any unauthorized opening of the camera case can be made to disable further operation of the camera until reset by a technician or by erasing the memory, or the like, in order to discourage a camera user from accessing or even attempting to access the removable memory.

FIG. 2 illustrates a basic physical form of a recyclable camera 57 that may contain the optical and electronic system of FIG. 1. Elements of FIG. 1 that are also included in FIG. 2 are identified by the same reference numbers but with either a prime (′) or small letter added. The user interface 15 (FIG. 1) includes a number of display and control devices on the outside of the case 11′ (FIG. 2). A power on/off switch 15a and a shutter switch 15b are frequently actuated by the user. A small rectangular image preview screen 15c, such as a liquid crystal display (LCD), is provided for viewing the current picture being taken, an image earlier captured by the camera and stored in its memory, and advertising messages from data stored in the camera memory. Alternatively, a separate visual display may be added for the advertising messages. An optical viewfinder 59 is also desirably included and can even have advertising images displayed during use. An audio loudspeaker or headphone connector 15d, if included, allows the playback of audio advertising data stored in the camera's memory at the time of manufacture or refurbishment of the camera, or by the camera user through a microphone (not shown) that may also be included on the camera.

Other various controls and switches are also included. Examples include a switch 15e to delete data of a picture from the internal memory, a switch 15f to display a stored picture, a switch 15g to scroll through stored pictures and advertising messages for viewing through the display 15c, and a switch 15h for initiating play of an advertising message. Data of stored pictures are read out of the camera through an electrical receptacle 53′, and advertising messages are written to the internal camera memory therethrough. In order to further reduce the ability for camera users to read the contents of the internal memory into a peripheral device such as a personal computer of photograph printer, and thus frustrate the business model upon which camera pricing is based, the processor 17 may encrypt the video data before storage in the memory 45. In order to minimize the cost of the camera, the picture screen 15c or the audio loudspeaker 15d or headphone jack may be omitted.

With reference to FIG. 3, a workstation that processes the image data read from the camera memory 45 (FIG. 1) through the receptacle 53′ (FIG. 2) is generally shown. A plug 61, complementary with the receptacle 53′, carries image data from the camera and advertising message data to the camera. Alternatively, wireless communication technique can be used that eliminates the need to physically connect with the camera. A computer server 63 processes the received image data. If the camera has encrypted the image data before storage in the camera memory, then the server 63 initially decrypts the data received from that memory. This server can be a personal computer, network server or the like. The processed image data are applied to some device 65 that utilizes these data. The device 65 can be a color printer that provides prints of the image data or some other non-volatile memory device that stores the image data such as a CD or DVD burner, a magnetic disc drive, a flash memory card or a magnetic tape drive. The processing performed by the server 63 also interfaces with the utilization device 65, such as including a software printer driver when the device 65 includes a printer, normal JPEG compression when the device 65 includes a CD or DVD storage unit, and the like.

Data of advertising messages may also be loaded into the camera memory through the plug 61 (FIG. 3) and receptacle 53′ (FIG. 2) from an advertising data server 67. Practically, the servers 63 and 67 are preferably implemented by a single computer system. If image data are received wirelessly from the camera, the advertising message data are preferably also wirelessly transmitted to the camera. The system of FIG. 3 is installed as part of the processing center to which cameras are returned when with image data stored therein.

An example of a recyclable camera that does not carry advertising messages, and methods of using it to capture image data are described in U.S. patent application Ser. No. 10/458,893, filed Jun. 10, 2003. The recyclable camera there described performs little or no image processing in order to minimize its cost. The server 63 (FIG. 3) performs any desired image corrections and/or enhancements instead. The camera sometimes also transmits image support data unique to the individual camera that are then used in the post-processing. One type of support data is a camera's calibration data.

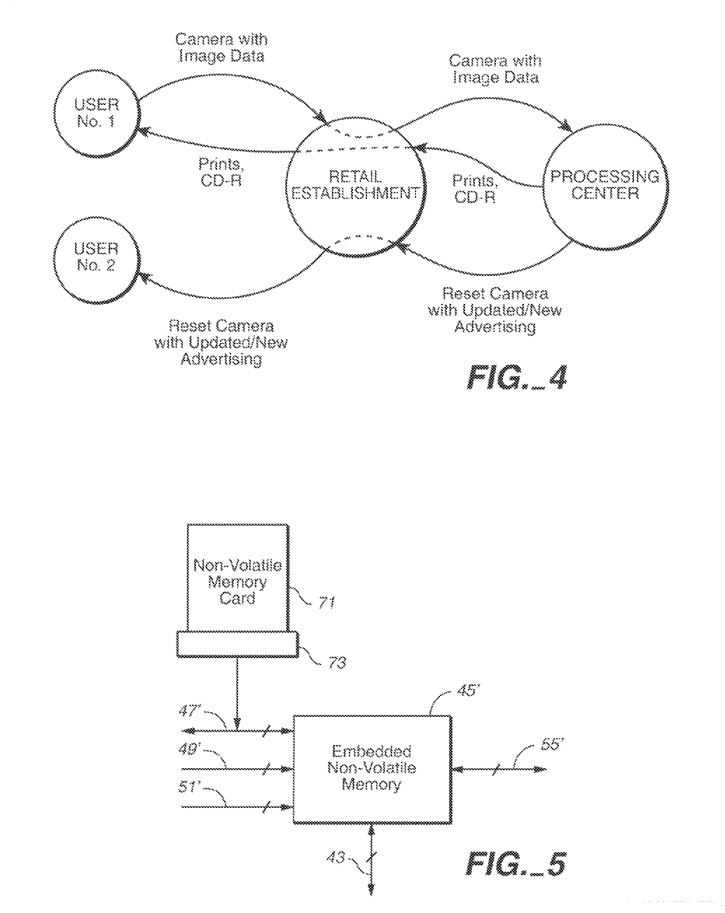

A camera is initially purchased by an individual user from a retail outlet. The camera has enough of its non-volatile memory 45 erased for storage of video data by a new camera purchaser. The memory 45 also contains data of advertising messages that are conveyed to the new camera purchaser in the course of pictures being taken and reviewed. After an allowed amount of image data are stored by the user, the camera automatically stops operating. FIG. 4 shows one cycle of use of a particular digital camera according to FIGS. 1 and 2, beginning with a user no. 1 taking the camera with its captured video data to a retail establishment dealing with such cameras. It need not be the same retail establishment as where user no. 1 purchased the camera but it must of course handle such cameras. The retail establishment can be a camera store, drug store, department store, discount store, or the like.

The retail establishment then sends the camera to a commercial processing center containing a workstation as described above with respect to FIG. 3. The image data stored in the non-volatile memory of the camera are then downloaded into a memory of the workstation. To the extent not done within the camera, these data may then be processed to correct and/or enhance the images. Photographic prints, a CD-R or DVD-R with the image data stored in a JPEG compressed form, and the like, as ordered by user no. 1 are then produced from the data and returned to the retail establishment. User no. 1 then would normally pick up his or her order from the retail establishment. Alternatively, the order can be shipped directly from the processing center to user no. 1.

The image data in the non-volatile memory of the camera are then erased by the processing center, new advertising message data uploaded, the camera physically refurbished, if necessary, and then sent back to the retail establishment for purchase by another user no. 2, and the process starts over again. The advertising message data may be for an image display of the camera or an audio loudspeaker or attached headphones, or can be for a combined audio-visual display. The camera may go through many such cycles before it needs to be taken out of service, such as about 4 to 8 such cycles.

The retail establishment can instead perform the functions of the processing center, and this is feasible especially with camera stores. A system according to FIG. 3 is then placed in the retail establishment. The processing center will typically support a large number of other retail establishments over a wide geographical region in order to be efficient. When it is desired that the advertising be targeted locally, it is therefore better that the retail establishment update or replace the advertising in a camera before reselling it. Alternatively, a regional processing center can work with the retail establishments to include data of advertising messages that conform to the needs of the localities where the retail establishments are located and do business.

Since there are benefits to uploading the advertising locally but the retail establishment may not want to acquire the system of FIG. 3 in order to perform all the functions of the processing center, the functions may be split. The processing center can continue to perform all the functions described above except the loading of updated or new advertising message data. The refurbished camera is then sent back to the retail establishment after the image data has been downloaded and printed by the processing center, as before, but this time without the advertising data therein. The retail establishment then, with the use of a lesser amount of equipment, uploads the updated and/or new advertising data into the camera's memory.

As a further alternative, the internal camera non-volatile memory 45 of FIG. 1 may be divided into two memories 45′ and 71, as shown in FIG. 5. The added memory 71 is preferably a removable memory card that inserts into a socket 73 within the camera. The memory 71 is preferably a suitable commercially available flash memory card, such as a Multi-Media Card (MMC), Secure Digital (SD) card, and the like. The memory 45′ functions as described above to store image data acquired by the camera and read out for processing. But the memory 45′ does not in this alternative store the advertising message data. These are stored in the memory card 71. The retail establishment can then more easily update the advertising in the refurbished recyclable cameras, by simply replacing the memory card 71. The advertiser can load multiple copies of the memory card 71 with the advertising content, and supply them to the retail establishment for easy insertion into the camera. Use of the memory card is particularly useful if large amounts of advertising message data are being stored, such as occurs if one or more movie trailers are included. Data are preferably stored in the memory card 71 in a compressed form, such as by use of MPEG, and the processor 17 then decompresses the data after reading the card 71. And, of course, the camera user will not be permitted access inside the camera in order to prevent tampering with the memory card or its advertising message data.

As another modification of the business system illustrated in FIG. 4, the user can purchase a camera once and keep the same one throughout many cycles of its use. The user sends that camera to the processing center when the allowed number of pictures have been taken, as before, but once the processing center has downloaded the picture data and uploaded new advertising message data, the camera is returned directly by the processing center to the same user. Of course, there can alternatively be a retail establishment, such as a camera shop, with which the user deals directly that is intermediate of the user and the processing center.

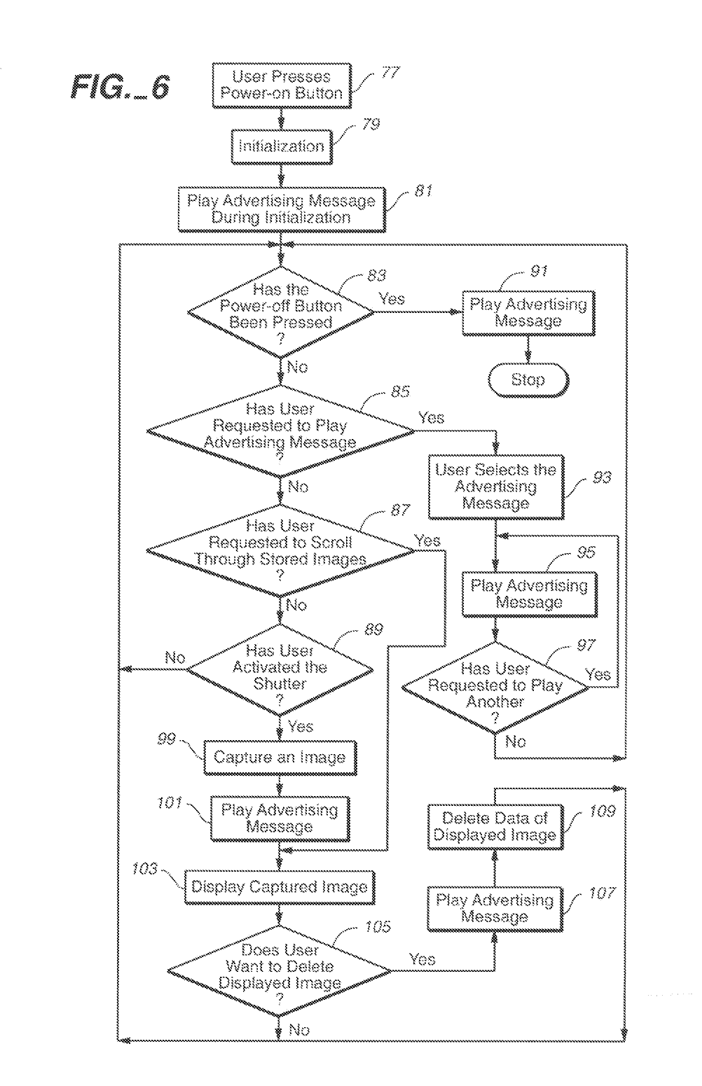

The flow diagram of FIG. 6 illustrates many aspects of the operation of the camera of FIGS. 1 and 2 that are possible. In the specific example shown, an advertising message is involuntarily played on the camera at four different points of its operation, with the user being able to voluntarily select play at another point. Of course, a specific implementation of the process shown may eliminate one or more of these points of play, and/or add others. If data of a single advertising message is stored in the camera memory, that same message will play each time. If data of multiple advertising messages are stored, one is usually selected to be played each time, although two or more messages could be played in succession instead. If only one of multiple messages is played, the messages can be selected for successive plays in the order in which they are stored in the memory, or by a random or pseudo-random selection. The advertising messages are most commonly visually displayed on the picture preview screen (15c of FIG. 2) of the camera, in this example, with the option of an accompanying audio track played through the camera's loudspeaker (15d of FIG. 2) or headphones jack. Alternatively, the advertising messages may be audio messages without any accompanying image displays. A single camera can even display image advertisements and reproduce audio advertisements simultaneously or in time sequence.

The process of FIG. 6 begins with a first step 77 when the user presses the camera's power-on button (15a of FIG. 2). The system then goes through an initialization process for a few seconds, per step 79, to load operating firmware into the processor, test operation of the camera system, and the like. During initialization and optionally thereafter, an advertising message may be played, as indicated by a step 81. The advertising message may be played as a visual display only, as an audio reproduction only, or with a combination of both. This is the first of several points in the operational example where a message may be played.

A next number of steps 83, 85, 87 and 89 allow the user to select among different operations of the camera system. The step 83 monitors whether the power-off button (15a of FIG. 2) has been pressed. If so the camera is turned off, but before doing so, an advertising message may be played, at a step 91.

The camera system optionally includes the ability for the user to voluntarily select and view an advertising message. This is indicated by a step 85, involving the user manipulating a camera control (the play button 15h of FIG. 2). This is desirably included when the content of a stored advertising message is of enough interest to a typical user that such access is expected to be made. A list of local restaurants, with some information about each of them, local movie theaters and similar types of information are expected to be of sufficient interest. Pre-views or trailers of movies that are playing in local theatres could be included. Such advertising messages may include an audio accompaniment. Additionally, certain types of messages may alternatively be audio alone, without a visual display. Since the advertising messages can be updated each time the camera is recycled, it is feasible to include information that has a short lifetime. It is only necessary that the information remain current for the average time that a camera is held by a user, which may be only a few weeks. This time will depend upon the number of pictures that the user is allowed to take before the camera must be recycled and the extent to which pictures may be deleted and replaced by new shots.

Another use of the voluntary advertising message access feature is to link it with an involuntarily played message. For example, a brief message can be played, at any one of the points indicated in FIG. 6, that advertises a current movie. A full trailer of that movie can then also be stored but not played unless the user makes the choice to do so at the step 85.

If the play of an advertising message is selected at the step 85, the user then selects one of several stored messages, if more than one exists, by displaying the messages or an abstract of each of them in time sequence on the display (15c of FIG. 2) in a step 93 (by manipulating the scroll button 15g of FIG. 2). Once an indication of the desired message appears on the display screen, the user may play it (by again pressing the play button 15h of FIG. 2). After playing the selected advertising message, the operation returns to the step 83 unless, in a step 97, the user has selected another of multiple stored advertising messages for playing.

Another type of message that may be maintained to be accessible by the camera user by steps 85, 93, 95 and 97 is a coupon that gives the user a free product or service from a business when the coupon is presented to the business by its display on the camera's display screen. Indeed, data of several such coupons can be stored in the camera memory when desirable.

If the power-off button has not been pushed (step 83), the user has not sought to view an advertising message (step 85), then a next step 87 of the operation of FIG. 6 asks whether the user has requested to scroll through the stored images (by use of the scroll button 15g of FIG. 2. If not, a next step 89 asks whether the shutter (15b of FIG. 2) has been pressed. If so, an image is captured and stored in the camera's memory, as indicated by a step 99. A typical user will want to look at an image in the display (15c of FIG. 2) of the picture just taken but before this image appears, a step 101 can cause an advertising message to appear on that display screen. Once the message has been displayed for a few seconds, then, in a step 103, the image of the picture just taken will appear. Alternatively, if the advertising message is audio and not visual, the audio message may be played in step 101 either simultaneously or in sequence with the image display in step 103.

Returning to the step 89, if the shutter has not been activated, the operation returns to the step 83. And if in the step 87, the user has requested to scroll through and display the captured images, the operation jumps to the step 103. Optionally, this jump from the step 87 could be to the step 101 instead in order to play an advertisement before the user is allowed to view a captured image. In this case when there is an audio advertising message without a visual component to be played, the advertising message may be played in response to a user command to display a stored image. The audio message may be played either simultaneously or in sequence with the image display.

As mentioned above, at least on commercial recyclable digital camera does not allow deletion of captured images except for the most recently taken image. The purpose of this is to shorten the time that the user keeps the camera since a deletion would allow the user to take yet another picture before reaching the limit of a number of pictures set for the camera. The price to the user for such a camera is based on the camera being recycled in rather short period of time. But it can be worth extending that cycle time if allowing the user to scroll through and delete any of the captured images provides additional advertising opportunities. Therefore, in this example, a step 105 responds to the user acting to delete a picture that is displayed on the screen (by pushing the button 15e of FIG. 2) by playing an advertising message, in a step 107. The visual display may optionally be accompanied by an audio component as part of the advertising message. After that message is played, the data of the selected image is deleted, per step 109. The operation then returns to the step 83. And if, in the step 105, the user is not seeking to delete an image, the operation returns directly to the step 83.

Similarly with others described above, the message play step 107 may play an audio message without a visual component to the advertising. This audio reproduction may occur simultaneously or in sequence with the image display 109. Play of the audio advertising message may be initiated by the user's request 105 to delete data of a stored image.

The most effective involuntary playing of advertising messages having a visual component is when the camera user is most likely to be looking at the camera' s display screen. The plays 101 and 107 are more likely to be seen by the user than the plays 81 and 91 since the user is then waiting to view something else on the screen. The voluntary play 95 is likely the most effective of all since it results from a camera user's request.

Companies or others providing advertising content will pay for the advertising opportunities in this case as they do when they advertise in magazines, on television, on radio, and the like. The camera is another but different advertising medium. Payments may be made to any of the camera manufacturer, processing center, retail establishment or another involved business, depending upon the exact business arrangement between them that is in place. Although these business entities may themselves include data of messages in the cameras that identify themselves, it is unlikely that they will advertise the making, distribution or use of the cameras and the processing services they provide. Rather, it is a primary purpose of the camera business system being described that one or more of these business entities involved with the cameras instead sell the camera advertising medium to others.

One way to judge the extent to which the users are being exposed to the stored advertising messages, and thus to have some data upon which advertising rates may be set, is to maintain a count within the camera of the number of times the stored advertising messages were played during the individual cycles of camera use. The processor 17 (FIG. 1) of the camera may be programmed to keep such a count. One or more counts are kept in the memory 45, and these counts are preferably read and thereafter reset to zero either when the captured picture data is downloaded from the camera or when a new advertising message data is uploaded to the camera memory.

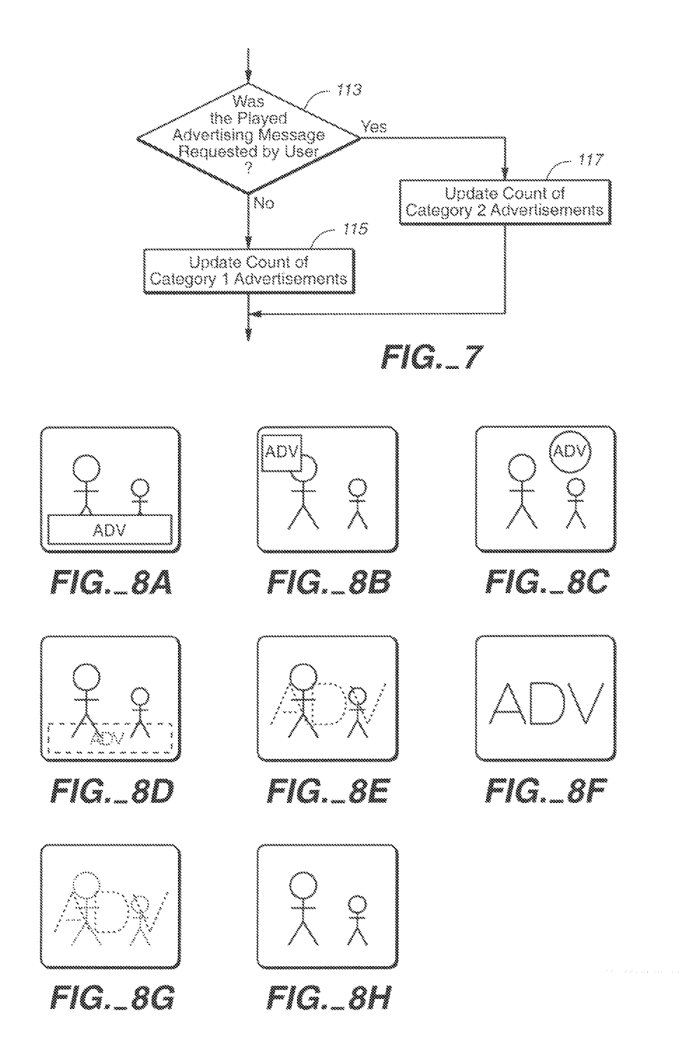

A few steps shown in FIG. 7 may be added to the flowchart of FIG. 6 to maintain advertising play counts in each camera. In this example, two such counts are maintained, one for the advertising plays that are more likely to be effective and the other count for all other plays. This can be included in each of the “Play Advertising Message” blocks of FIG. 6. After the advertising message has been set for play, or after it has been played, a step 113 asks whether the message was involuntarily played or voluntarily selected by the user. If involuntary, a step 115 increments one count and if voluntary, a step 117 increments another count. Based upon the number of plays, these counts can be directly used to charge the advertiser, with advertising rates being set depending upon where in the camera's operational cycle the advertisement was played. After the counts are incremented, the processing proceeds to the steps after the “Play Advertising Message” step in which the count was updated.

It may also be important because of their different advertising values to distinguish involuntary plays where the user is more likely to be looking at the display screen than those involuntary plays where he or she is not likely to be so looking. If so, a third count may be maintained, or this count kept in place of one of the other two counts indicated in FIG. 7. Distinguishing and separately tracking audio plays from video plays and from multi-media plays may also be important in some applications.

When the play of an advertising message includes a visual display on the camera's display screen, or if the play is totally visual, this display can be in some instances the only thing that is being displayed at the time. An advertising message may appear during initialization, upon shutdown, before a captured image appears, and the like. With the goal of increasing the chances that the camera user actually views and takes in the advertising messages, the time of their occurrence and their visual content are carefully chosen. To further these goals, an advertising message may appear on the screen (15c of FIG. 2) at the same time as an image of a picture taken by the camera, rather than at a separate time. This can increase the effectiveness of the advertising since it occurs when the user is most likely to be intently looking at the display screen to observe a picture that the user has taken with the camera.

There are many ways that the camera processor (17 of FIG. 1) can combine data from its memory (45 of FIG. 1) of a picture taken with the camera and of an advertising message uploaded as part of the camera recycling process. The advertising display may have a degree of translucence so that the captured image may be viewed through it. Or, conversely, the picture image can appear at least partially transparent with the advertising message appearing as a light background image or wallpaper. This allows the advertising message to be relative large, even extending over the entire display, while allowing the entire captured image to be viewed at the same time. If it instead blocks out the captured image, the advertising display preferably overlies a selected small portion of the captured picture image display so as not to block out an excessive portion of the image being displayed at the same time. The small advertising display can still be quite effective when the content is a company logo, product trademark, or the like. Further, the advertising display need not always remain static but can be given some motion with respect to the display screen and captured picture being displayed on it. The advertising display may appear for only a predetermined amount of time, especially if it interferes with the picture. In any of these various forms, the visual display may or may not be accompanied by sound.

FIGS. 8A-8H illustrate a few examples of a camera display (15c of FIG. 2) that combines reproduction of a picture taken (of two people shown in stick figure format) and an advertising message (shown as ADV). The advertising message is reproduced from data uploaded into the camera memory (45 of FIG. 2 or 71 of FIG. 5) the last time it was recycled. The picture may either be reproduced from data earlier acquired and stored in the camera memory (45 of FIG. 2 or 45′ of FIG. 5) or come directly from image data being acquired in real time by the camera sensor (31 of FIG. 1).

The display of FIG. 8A shows the picture captured by the camera with an advertising message shown in a rectangle near the bottom of the display. The advertising could alternatively be in the form of a banner extending completely across the display. In FIG. 8B, the advertising message is confined to a rectangle near one corner of the display. In these examples, the advertising messages totally block any part of the captured image in the areas designated for the advertising. These advertising areas are most conveniently fixed in size and position on the display. For this reason, the advertising message preferably appears for only a few seconds at the beginning of the display of the captured image, and then disappears.

In order to minimize the conflict between display of the captured image and the advertising message, they may be dynamically integrated by processing data of the two within the camera for each display. For example, the size and position of the advertising message may be chosen to minimize visual interference with the image display. One way this is done is for the camera processor (17 of FIG. 1) to first identify areas of a particular captured image that have relatively uniform characteristics, such as in its intensity and color balance. These areas are likely the sky, the ground, and the like, that are not of particular interest to the viewer. Data of the advertising message are then combined with data of the captured image and the combination is displayed. An example of this is shown in FIG. 8C, where the advertising message does not overlie the people in the picture captured by the user.

Rather than blocking out the captured image, the advertising message may be displayed in a partially transparent form. FIG. 8D shows such a display, which is the same as that of FIG. 8A except that the viewer may see the captured image through the rectangular advertising display. With this see-through technique, the advertising message may be made larger, and even occupy the entire display screen. FIG. 8E shows such an example.

In any of the foregoing display examples, the advertising message may be displayed with its content moving through its designated space with respect to the captured image. If a certain brand of automobile is being advertised, for example, a picture of the automobile may be moved across some portion or the entire display screen.

The advertising message and captured picture image may also be faded in and out during the time of the display. An example of this is shown by FIGS. 8F-8H. At the beginning, only the advertising message is displayed, with full intensity, over a portion or the entire display screen, as illustrated in FIG. 8F. After some period of time, perhaps only a few seconds, the advertising message fades out while the captured image fades in, as illustrated in FIG. 8G. For an instant, both images are visible, overlying each other. Next, the advertising message fades out completely while the captured image fades in to its full intensity, as shown in FIG. 8H. The fade-ins can come from one side of the display and move across it, from the center and move out across the display, and the like. The fade-outs can operate in the reverse direction.

Although the various aspects of the present invention have been described with respect to exemplary embodiments thereof, it will be understood that the present invention is entitled to protection within the full scope of the appended claims. All patents, patent applications, articles and other documents, publications and things referenced within this document are hereby incorporated herein by this reference in their entirety for all purposes.

It is claimed:

1. A method of communicating an advertising message by a recyclable digital camera, the method comprising the acts of:
receiving at least one advertising message, by a digital camera, during recycling of the digital camera;
playing an advertising message, by the digital camera, during initialization of the digital camera based on the at least one advertising message received during recycling;
detecting user activation of the digital camera to capture image data once the initialization is completed;
storing image data captured by the digital camera;
displaying, by the digital camera, the captured image data; and
playing a selected advertising message by the digital camera, wherein the selected advertising message is selected based on user operation of the camera during display of captured image data.

2. The method of claim 1, wherein receiving at least one advertising message, by the digital camera, relates to exchanging a removable non-volatile memory from within the digital camera.

3. The method of claim 1, wherein recycling relates to processing image data stored by the digital camera prior to redistribution of the digital camera.

4. The method of claim 1, wherein an advertising message relates to one or more of advertising messages for one or more of goods, services, coupons, and directories of restaurants or movie theatres.

5. The method of claim 1, wherein the selected advertising message is played as a visual advertising display on a screen during display of image data stored in the digital camera.

6. The method of claim 1, wherein the selected advertising message is randomly selected based on the user operation.

7. The method of claim 1, wherein only a portion of the selected advertising message is played based on the user operation of the digital camera.

8. The method of claim 1, wherein the selected advertising message is selected based on content of the advertising message data relating to one or more of audio and video data.

9. The method of claim 1, further comprising playing the at least one advertising message by the digital camera immediately prior to, during, or immediately following capture of image data by the digital camera.

10. The method of claim 1, further comprising monitoring a number of times that an advertising message is played by the digital camera, wherein payment to a first entity from a second entity is based on the number of times an advertising message is played.

11. The method of claim 1, further comprising receiving at least one new advertising message, by the digital camera, during the recycling, wherein the new advertising message is associated with a first entity receiving payment from a second entity for the at least one new advertising message.

12. A recyclable digital camera comprising:
an image sensor for detecting image data;
a memory; and
a processor coupled to the memory and image sensor, the processor configured to:
receive at least one advertising message during recycling of the digital camera;
play an advertising message during initialization of the digital camera based on the at least one advertising message received during recycling;
detect user activation of the digital camera to capture image data once the initialization is completed;
store image data captured by the digital camera;
display the captured image data; and
play a selected advertising message by the digital camera, wherein the selected advertising message is selected based on user operation of the camera during display of captured image data.

13. The recyclable digital camera of claim 12,, wherein receiving at least one advertising message relates to exchanging a removable non-volatile memory from within the digital camera.

14. The recyclable digital camera of claim 12, wherein recycling relates to processing image data stored by the digital camera prior to redistribution of the digital camera.

15. The recyclable digital camera of claim 12, wherein an advertising message relates to one or more of advertising messages for one or more of goods, services, coupons, and directories of restaurants or movie theatres.

16. The recyclable digital camera of claim 12, wherein the selected advertising message is played as a visual advertising display on a screen during display of image data stored in the digital camera.

17. The recyclable digital camera of claim 12, wherein the selected advertising message is randomly selected based on the user operation.

18. The recyclable digital camera of claim 12, wherein only a portion of the selected advertising message is played based on the user operation of the digital camera.

19. The recyclable digital camera of claim 12, wherein the selected advertising message is selected based on content of the advertising message data relating to one or more of audio and video data.

20. The recyclable digital camera of claim 12, wherein the processor is further configured to play the at least one advertising message immediately prior to, during, or immediately following capture of image data by the digital camera.

21. The recyclable digital camera of claim 12, wherein the processor is further configured to monitor a number of times that an advertising message is played by the digital camera, wherein payment to a first entity from a second entity is based on the number of times an advertising message is played.

22. The recyclable digital camera of claim 12, wherein the processor is further configured to receive at least one new advertising message, by the digital camera, during the recycling, wherein the new advertising message is associated with a first entity receiving payment from a second entity for the at least one new advertising message.
